(19) United States
(12) Patent Application Publication
(10) Pub. No.: US 2022/0309396 A1
(43) Pub. Date: Sep. 29, 2022

(54) INFERENCE DEVICE

(71) Applicant: NTT DOCOMO, INC., Chiyoda-ku (JP)

(72) Inventors: Masato HASHIMOTO, Chiyoda-ku (JP); Hisashi KURASAWA, Chiyoda-ku (JP); Naoharu YAMADA, Chiyoda-ku (JP)

(73) Assignee: NTT DOCOMO, INC., Chiyoda-ku (JP)

(21) Appl. No.: 17/615,888

(22) PCT Filed: Jun. 3, 2020
(86) PCT No.: PCT/JP2020/021978

§ 371 Date: Dec. 2, 2021

(30) Foreign Application Priority Data
Jun. 10, 2019 (JP) 2019-108036

(51) Int. Cl. G06N 20/00; G06K 9/62

(52) U.S. Cl. CPC G06N 20/00; G06K 9/6262

(57) ABSTRACT

An inference device includes a survival period information input unit configured to acquire survival period information indicating a change in a value of a feature amount over a period of time from a plurality of observation subjects for each feature amount, a feature amount change model construction unit configured to construct a feature amount change model, an attribute learning information input unit configured to acquire attribute learning information, a feature amount change inference unit configured to derive a value of each feature amount for each period, an attribute inference model construction unit configured to construct an attribute inference model, and a model evaluation unit configured to derive accuracy of inference of each attribute inference model in each period.

### TECHNICAL FIELD

An aspect of the present invention relates to an inference device.

### BACKGROUND ART

Since the past, a technique of inferring an attribute of an observation subject by inputting the characteristics (feature amounts) of the observation subject to an inference model has been known. For example, a system disclosed in Patent Literature 1 repeatedly performs feature amount selection and model evaluation to perform the feature amount selection in an exploratory manner with the aim of improving the accuracy of inference of an inference model.

### CITATION LIST

### Patent Literature

[Patent Literature 1] Japanese Unexamined Patent Publication No. 2017-167980

### SUMMARY OF INVENTION

### Technical Problem

Here, in the related art as described above, the deterioration of an inference model over time is not taken into consideration. That is, in the related art, a change in the accuracy of inference due to the elapse of a period is not known, and thus it is not possible to construct an inference model considering deterioration over time. Due to this, the constructed inference model deteriorates early, and thus there may be concern of a significant decrease in the accuracy of inference over a period of time. In addition, since the update frequency of the inference model cannot be appropriately set, it is difficult to accurately calculate the development cost of an inference device.

An aspect of the present invention was contrived in view of such circumstances, and an object thereof is to appropriately infer a change in the accuracy of inference over a period of time.

### Solution to Problem

According to an aspect of the present invention, there is provided an inference device including: a first acquisition unit configured to acquire survival period information indicating a change in a value of a feature amount over a period of time from a plurality of observation subjects for each feature amount; a first model construction unit configured to construct a feature amount change model that predicts a change in a value of a feature amount for each feature amount by performing a regression analysis using the survival period information; a second acquisition unit configured to acquire attribute learning information relating to each feature amount from a plurality of observation subjects; a feature amount change inference unit configured to derive a value of each feature amount for each period from a plurality of observation subjects by applying the feature amount change model of each feature amount to the attribute learning information; a second model construction unit configured to construct an attribute inference model that infers an attribute of an observation subject for each combination of each feature amount; and a model evaluation unit configured to derive accuracy of inference of each attribute inference model in each period on the basis of a value of each feature amount in each period for a plurality of observation subjects derived by the feature amount change inference unit.

In the inference device according to an aspect of the present invention, the value of a feature amount for each period is derived by the feature amount change model constructed on the basis of the survival period information. The accuracy of inference in each period of the attribute inference model constructed for each combination of each feature amount is derived on the basis of the value of each feature amount in each period for a plurality of observation subjects. In this way, in the inference device according to an aspect of the present invention, since the accuracy of inference of each attribute inference model in each period is derived in consideration of a change in the value of a feature amount due to the elapse of a period, it is possible to appropriately infer a change in the accuracy of inference over a period of time (deterioration of each attribute inference model over time) for each attribute inference model. This makes it possible to select an attribute inference model which is not likely to deteriorate early and to suppress a decrease in the accuracy of inference over a period of time. In addition, since a change in the accuracy of inference over a period of time (period of deterioration over time) can be specified, it is possible to appropriately set the update frequency of an attribute inference model and to calculate the development cost of the inference device or the like with a high degree of accuracy.

### Advantageous Effects of Invention

According to an aspect of the present invention, it is possible to appropriately infer a change in the accuracy of inference over a period of time.

### BRIEF DESCRIPTION OF DRAWINGS

FIG. 1 is a diagram illustrating a functional configuration of an inference device according to the present embodiment.

FIG. 2 is a diagram illustrating construction of a feature amount change model.

FIG. 3 is a diagram illustrating inference of a change over time for the value of a feature amount.

FIG. 4 is a diagram illustrating an example of a combination set of feature amounts.

FIG. 5 is a diagram illustrating evaluation of the accuracy of inference of an attribute inference model.

FIG. 6 is a diagram illustrating an inference accuracy guarantee curve of a combination of each feature amount.

FIG. 7 is a diagram illustrating a score and a validity period of a combination of each feature amount.

FIG. 8 is a diagram illustrating an inference process of inferring a user's attribute.

FIG. 9 is a flowchart illustrating processing which is executed by an inference device.

FIG. 10 is a flowchart illustrating processing which is executed by the inference device.

FIG. 11 is a flowchart illustrating processing which is executed by the inference device.

FIG. 12 is a flowchart illustrating processing which is executed by the inference device.

FIG. 13 is a flowchart illustrating processing which is executed by the inference device.

FIG. 14 is a diagram illustrating a hardware configuration of the inference device.

### DESCRIPTION OF EMBODIMENTS

Hereinafter, an embodiment of the present invention will be described in detail with reference to the accompanying drawings. In the description of the drawings, the same or equivalent components are denoted by the same reference numerals and signs, and thus description thereof will not be repeated.

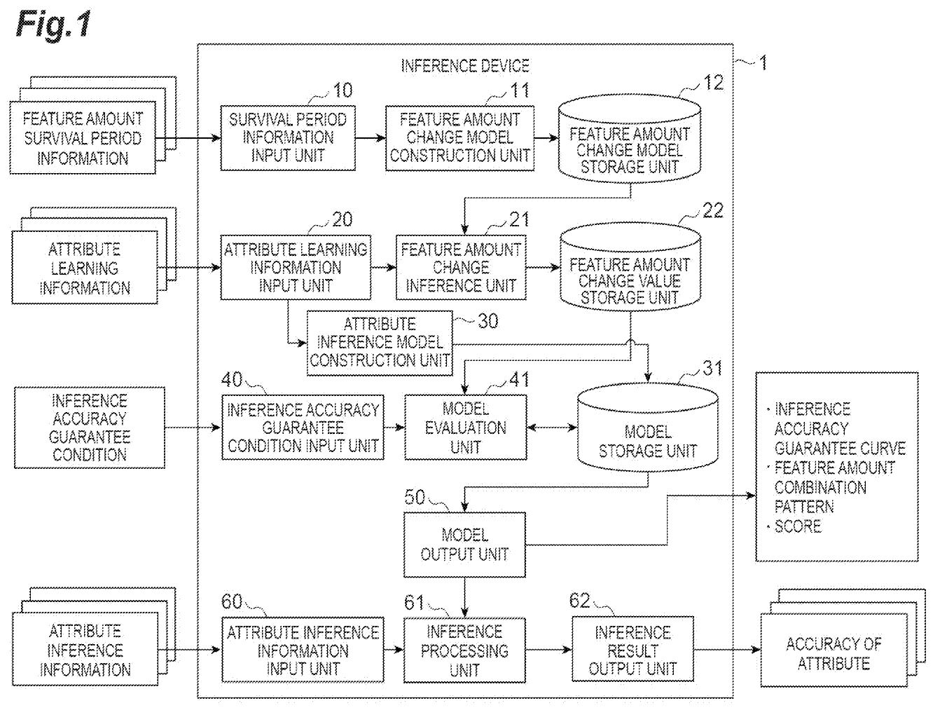

FIG. 1 is a diagram illustrating a functional configuration of an inference device 1 according to the present embodiment. The inference device 1 constructs an attribute inference model that infers a user's attribute which is an example of an observation subject. Meanwhile, the inference device 1 may construct an attribute inference model that infers attributes of observation subjects other than a user (that is, a person). In the following description, the inference device 1 is assumed to construct an attribute inference model that infers a user's attribute. The attribute inference model is designed to use a user's characteristic (feature amount) as input to output the user's attribute which is an inference result. A user's feature amount is information which is obtained from the user's behavior, nature, or the like and is, for example, “whether the user is playing music A” (the user's behavior), a “likes movies” (the user's nature), or the like. The value of a user's feature amount is indicated by, for example, a binary value of “1” or “0,” and with respect to, for example, the feature amount of “whether the user is playing music A,” the value is indicated as “1” when the music is being played and “0” when the music is not being played. A user's attribute is the user's nature which is inferred on the basis of the values of one or a plurality of users' feature amounts. For example, a user's attribute of a “likes enka” is inferred in accordance with the values of feature amounts of “whether the user is playing music A” and “whether the user is playing music B.” Meanwhile, a user's attribute may be indicated by a score rather than a binary value (for example, “likes” or “dislikes”). That is, for example, a user's attribute of a “likes enka” may be indicated by a score in accordance with the values of a plurality of feature amounts.

The inference device 1 constructs an attribute inference model for each combination of feature amounts (the details will be described later), and derives the accuracy of inference in each period for each attribute inference model. The accuracy of inference in each period is derived in this manner, so that it is possible to appropriately infer a change in the accuracy of inference over a period of time (deterioration of an attribute inference model over time). This makes it possible to specify an attribute inference model which is not likely to deteriorate over time among attribute inference models and to estimate a user's attribute with a high degree of accuracy over a long period of time using the attribute inference model. Hereinafter, the detailed function of the inference device 1 will be described.

As shown in FIG. 1, the inference device 1 includes a survival period information input unit 10 (a first acquisition unit), a feature amount change model construction unit 11 (a first model construction unit), a feature amount change model storage unit 12, an attribute learning information input unit 20 (a second acquisition unit), a feature amount change inference unit 21, a feature amount change value storage unit 22, an attribute inference model construction unit 30 (a second model construction unit), an attribute inference model storage unit 31, an inference accuracy guarantee condition input unit 40 (a third acquisition unit), a model evaluation unit 41, a model output unit 50, an attribute inference information input unit 60 (a fourth acquisition unit), an inference processing unit 61, and an inference result output unit 62.

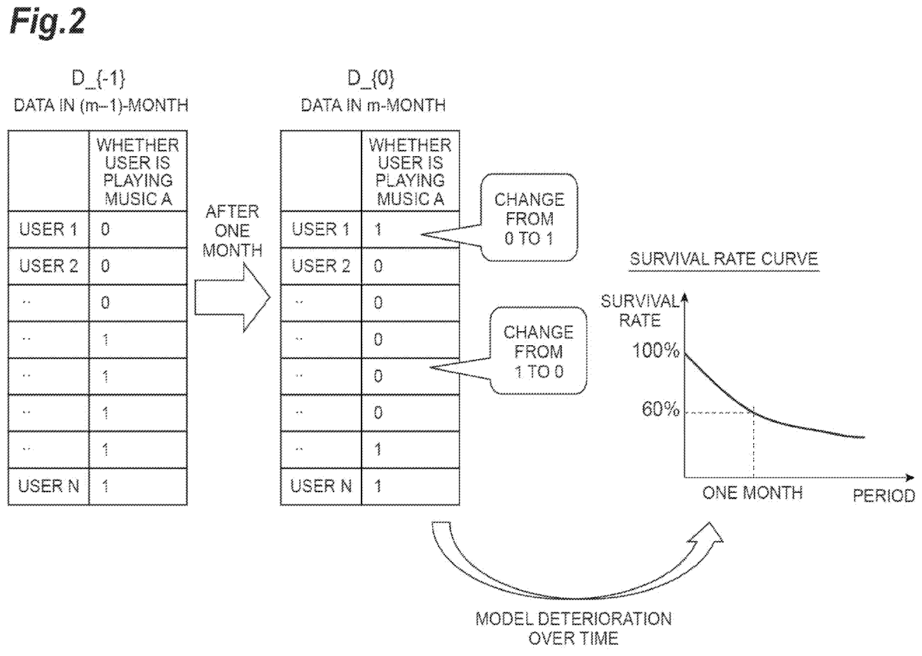

The survival period information input unit 10 acquires feature amount survival period information (survival period information) indicating a change in a feature amount over a period of time from a plurality of users for each feature amount. The survival period information input unit 10 may acquire the above-described feature amount survival period information from each of a plurality of users, or may acquire the information from an external device for a plurality of users together. FIG. 2 shows feature amount survival period information consisting of two pieces of data, that is, data of a plurality of users in (m−1)-month (feature amount value) D_{−1} and data of a plurality of users in m-month (feature amount value) D with respect to the feature amount of “whether the user is playing music A.” That is, FIG. 2 shows a change in the feature amount of “whether the user is playing music A” over a period of time (passage of one month) as the feature amount survival period information. Meanwhile, as the feature amount survival period information, data of not only two periods as shown in FIG. 2 but also three or more periods may be used. The survival period information input unit 10 outputs the acquired feature amount survival period information to the feature amount change model construction unit 11.

The feature amount change model construction unit 11 constructs a feature amount change mode that predicts a change in the value of a feature amount for each feature amount by performing a regression analysis using the feature amount survival period information. In the example shown in FIG. 2, when the data in (m−1)-month (feature amount value) D_{−1} and data in m-month (feature amount value) D_{0} are compared with each other, the values of feature amounts of some users are changed. The feature amount change model construction unit 11 constructs a feature amount change model by modeling such a change over time through a regression analysis. The feature amount change model construction unit 11 may construct a feature amount change model by, for example, applying a Weibull distribution to the feature amount survival period information. In a case where the Weibull distribution is used, as shown in the right figure of FIG. 2, a survival rate analysis is performed and the probability of a change over time is represented by a survival rate curve. The example of the survival rate curve shown in FIG. 2, shows that the value of the feature amount changes with a probability of 40% after one month (a survival rate is 60%).

The feature amount change model storage unit 12 stores (saves) the feature amount change model constructed by the feature amount change model construction unit 11.

The attribute learning information input unit 20 acquires attribute learning information relating to each feature amount from a plurality of users. Here, the attribute learning information is assumed to include information relating to a feature amount for which a feature amount change model is constructed by the feature amount change model construction unit 11. The attribute learning information input unit 20 outputs the acquired attribute learning information to the feature amount change inference unit 21 and the attribute inference model construction unit 30.

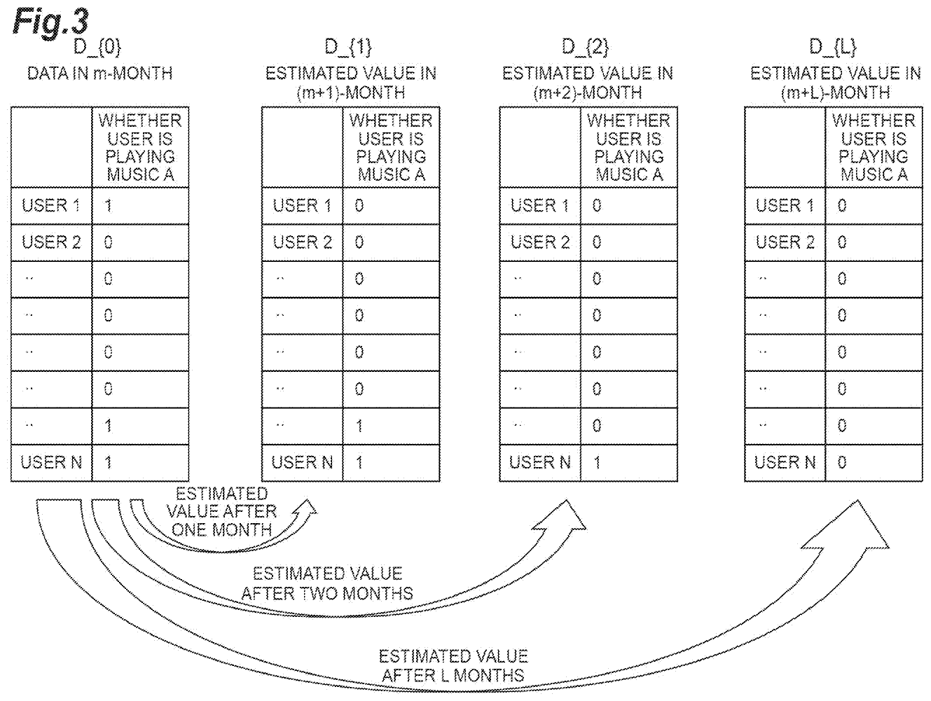

The feature amount change inference unit 21 derives the value (change value) of each feature amount for each period from a plurality of users by applying the feature amount change model of each feature amount to the attribute learning information. The feature amount change inference unit 21 acquires a feature amount change model by referring to the feature amount change model storage unit 12. The feature amount change inference unit 21 derives the value (change value) of each user's feature amount in each period by inputting the attribute learning information to the feature amount change model for each feature amount. In the example shown in FIG. 3, data in m-month (feature amount value) D_{0} of “whether the user is playing music A” which is a feature amount is obtained on the basis of each user's attribute learning information. In this case, the feature amount change inference unit 21 derives the value (change value) of a feature amount of each month (after one month, after two months, . . . , after L months) by applying the feature amount change model of “whether the user is playing music A” to the data in m-month D_{0}.

The feature amount change value storage unit 22 stores (saves) the value (change value) of each feature amount for each period derived by the feature amount change inference unit 21.

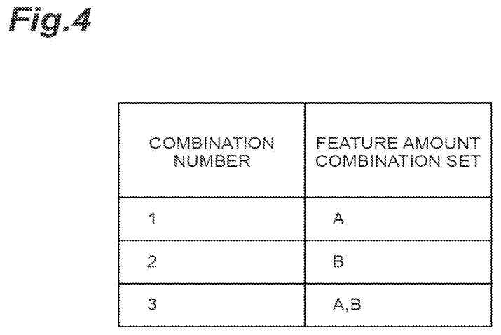

The attribute inference model construction unit 30 constructs an attribute inference model that infers a user's attribute for each combination of each feature amount. The combination of each feature amount is, for example, all possible combinations of each feature amount used when a user's attribute is inferred. It is now assumed that there are “whether the user is playing music A” and “whether the user is playing music B” as feature amounts. In this case, as shown in FIG. 4, for the combinations of feature amounts, there are three possible types, that is, “whether the user is playing music A” alone indicated by combination number 1 (denoted as “A” in FIG. 4), “whether the user is playing music B” alone indicated by combination number 2 (denoted as “B” in FIG. 4), and a combination of “whether the user is playing music A” and “whether the user is playing music B” indicated by combination number 3 (denoted as “A and B” in FIG. 4). In this case, the attribute inference model construction unit 30 constructs an attribute inference model for each of the three types of combinations.

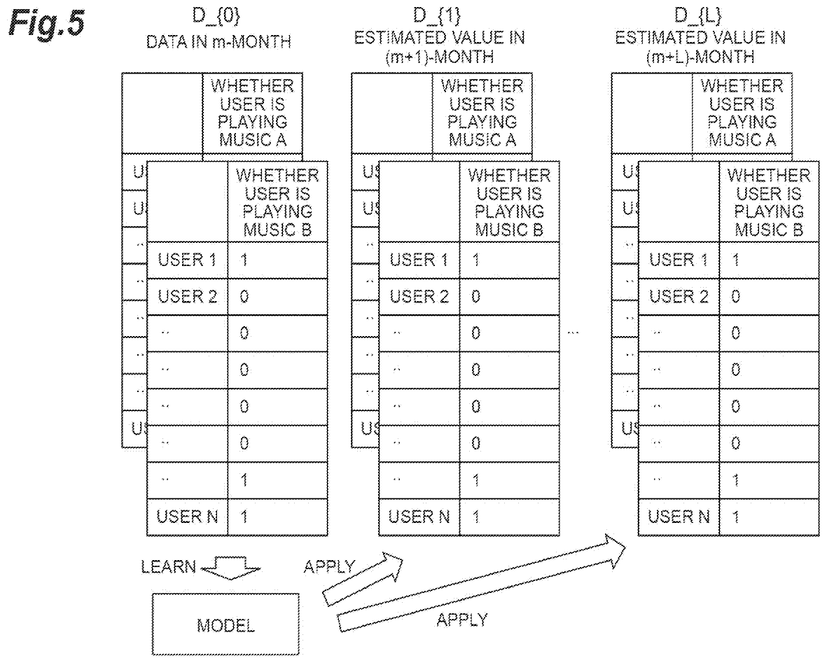

Now, a case where an attribute inference model is constructed with respect to, for example, a combination of “whether the user is playing music A” and “whether the user is playing music B” will be considered. In this case, as shown in FIG. 5, the attribute inference model construction unit 30 constructs an attribute inference model of a combination of “whether the user is playing music A” and “whether the user is playing music B” by learning data in m-month (feature amount value) D_{0} of “whether the user is playing music A” and data in m-month (feature amount value) D_{0} of “whether the user is playing music B” which are attribute learning information.

The attribute inference model storage unit 31 stores (saves) an attribute inference model for each combination of each feature amount constructed by the attribute inference model construction unit 30.

The inference accuracy guarantee condition input unit 40 acquires a guarantee condition which is a condition regarding a guarantee period of a predetermined accuracy of inference. The guarantee condition is defined by a period X for which the target value (Y %) of the accuracy of inference is continuously achieved. The inference accuracy guarantee condition input unit 40 outputs the guarantee condition to the model evaluation unit 41.

The model evaluation unit 41 derives the accuracy of inference of each attribute inference model in each period on the basis of the value (change value) of each feature amount in each period for a plurality of users derived by the feature amount change inference unit 21, and evaluates each attribute inference model. In the example shown in FIG. 5, the model evaluation unit 41 refers to the feature amount change value storage unit 22 to acquire the value of each feature amount in (m+1)-month, (m+2)-month, . . . , (m+L)-month (that is, the value of “whether the user is playing music A” and the value of “whether the user is playing music B”) with m-month as a reference. The model evaluation unit 41 inputs the value of the feature amount to the attribute inference model of a combination of “whether the user is playing music A” and “whether the user is playing music B” for each period, derives the accuracy of inference of the attribute inference model, and evaluates the attribute inference model. The model evaluation unit 41 evaluates the accuracy of inference of the attribute inference model in each period using, for example, k-fold cross-validation. The evaluation value is, for example, Accuracy (correct answer rate). Since a change in the value of a feature amount becomes larger as the period elapses, the accuracy of inference of the attribute inference model deteriorates as the period elapses.

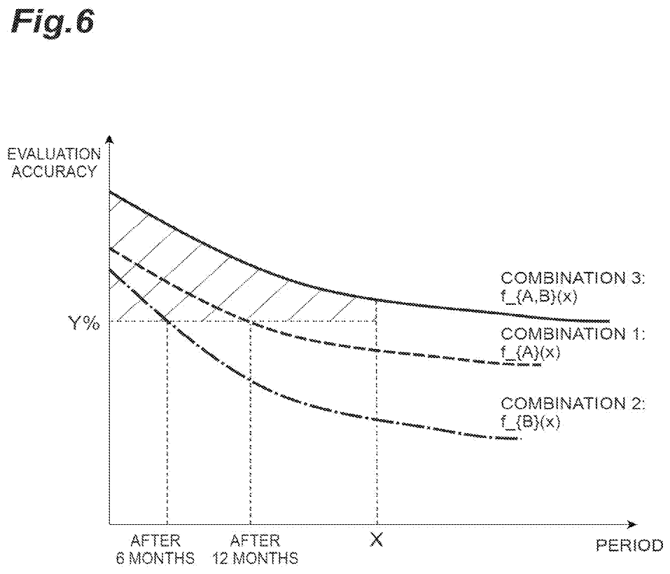

The model evaluation unit 41 generates an inference accuracy guarantee curve on the basis of the derived evaluation value in each period. FIG. 6 is a diagram illustrating an inference accuracy guarantee curve of a combination of each feature amount (see FIG. 4). In FIG. 6, the horizontal axis represents an elapsed period, the vertical axis represents an evaluation accuracy (%), a period X of a guarantee condition is shown on the horizontal axis, and a target value Y of the accuracy of inference is shown on the vertical axis. In the example shown in FIG. 6, the model evaluation unit 41 generates an inference accuracy guarantee curve of an attribute inference model based on combination number 1: “whether the user is playing music A,” an inference accuracy guarantee curve of an attribute inference model based on combination number 2: “whether the user is playing music B,” and an inference accuracy guarantee curve of an attribute inference model based on combination number 3: a combination of “whether the user is playing music A” and “whether the user is playing music B.” Each inference accuracy guarantee curve is determined by connecting coordinates determined by a period and an evaluation value (correct answer rate) in the period with a curve (connecting coordinates existing only for a period in which an evaluation value is derived with a curve). Here, in the example shown in FIG. 6, only the inference accuracy guarantee curve of the attribute inference model based on combination number 3: a combination of “whether the user is playing music A” and “whether the user is playing music B” achieves the target value Y of the accuracy of inference in the period X (that is, the guarantee condition is satisfied). The model evaluation unit 41 puts a high valuation on, for example, an attribute inference model in which an inference accuracy guarantee curve satisfies the guarantee condition.

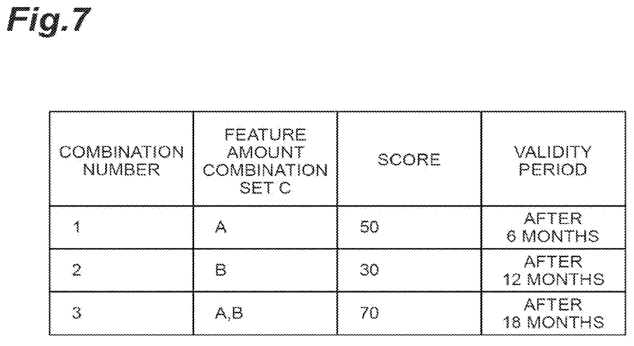

In the example shown in FIG. 6, the model evaluation unit 41 derives the size of a region in which the evaluation accuracy is higher than the target value Y of the accuracy of inference in an inference accuracy guarantee curve as a score of the inference accuracy guarantee curve. In addition, the model evaluation unit 41 derives a period in which the accuracy of inference is higher than the target value Y of the accuracy of inference in an inference accuracy guarantee curve (a period in which a predetermined accuracy of inference related to the guarantee condition is satisfied) as a validity period (model validity period) of the inference accuracy guarantee curve. FIG. 7 is a diagram illustrating a score and a validity period of a combination of each feature amount (inference accuracy guarantee curve). As shown in FIG. 7, in the above-described example, the attribute inference model based on combination number 3: a combination of “whether the user is playing music A” and “whether the user is playing music B” has a highest score and a longest validity period.

The model evaluation unit 41 stores a combination of each feature amount in which an attribute inference model is constructed, each generated inference accuracy guarantee curve, and the score and validity period of each inference accuracy guarantee curve in the attribute inference model storage unit 31.

The model output unit 50 selects and outputs an attribute inference model which is highly evaluated by the model evaluation unit 41. The model output unit 50 outputs, for example, an attribute inference model in which the accuracy of inference in each period derived by the model evaluation unit 41 satisfies the guarantee condition (that is, a validity period is longer than the period X of the guarantee condition). The model output unit 50 may output an attribute inference model having a highest accuracy in which the inference accuracy guarantee condition is satisfied. The model output unit 50 refers to the attribute inference model storage unit 31 to output an inference accuracy guarantee curve of the attribute inference model to be output, a combination pattern of feature amounts, and a score and a validity period to an external device (not shown) and the inference processing unit 61. The external device (not shown) referred to here is, for example, a display device that displays information to a user or the like.

The attribute inference information input unit 60 acquires attribute inference information. The attribute inference information is information relating to a user's feature amount which is input from the user whose attribute is inferred. Here, the attribute inference information is information relating to the feature amount of an attribute inference model which is output to the inference processing unit 61 by the above-described model output unit 50. The attribute inference information input unit 60 outputs the attribute inference information to the inference processing unit 61.

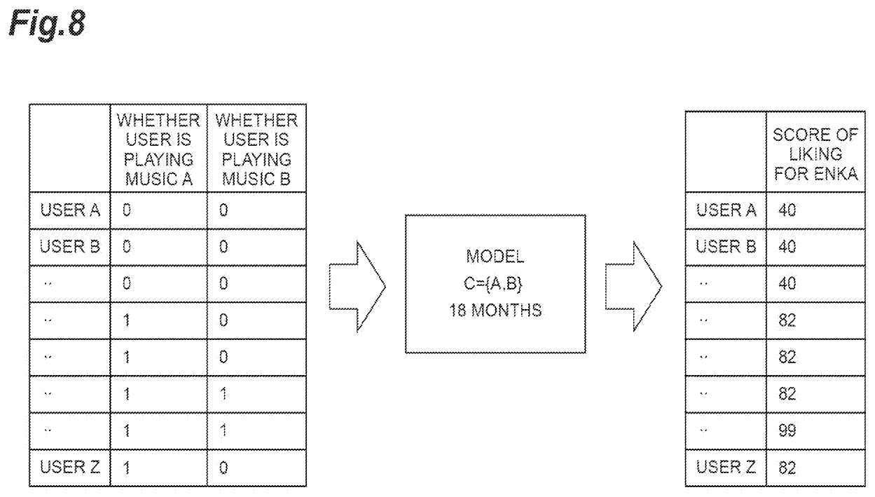

The inference processing unit 61 infers a user's attribute by inputting the attribute inference information to the attribute inference model which is output by the model output unit 50. For example, in the example shown in FIG. 8, “whether the user is playing music A” and “whether the user is playing music B” are input to the attribute inference model (validity period: 18 months) as the attribute inference information, and the score of a user's attribute of a “likes enka” is derived (inferred) for each user. The inference processing unit 61 outputs the inference result to the inference result output unit 62.

The inference result output unit 62 outputs an inference result of the inference processing unit 61 to an external device (not shown). The inference result output unit 62 outputs a score (estimated value) which is the accuracy of a user's attribute as the inference result, and outputs the validity period of an attribute inference model used for inference as the guarantee period of the inference result.

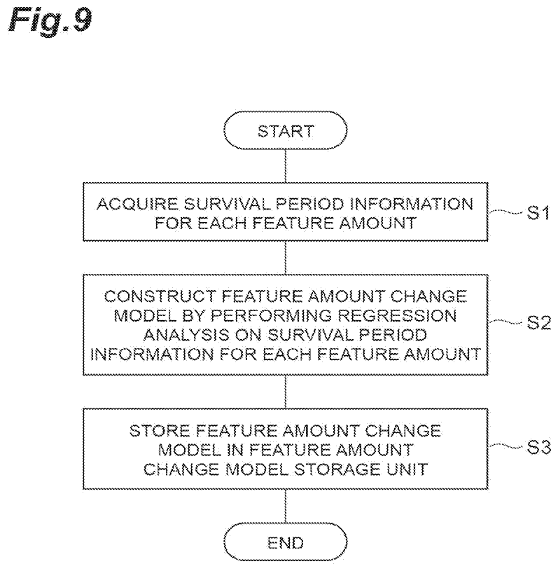

Next, processing which is executed by the inference device 1 will be described with reference to FIGS. 9 to 13.

FIG. 9 is a flowchart illustrating processing related to the construction of a feature amount change model. As shown in FIG. 9, in the inference device 1, feature amount survival period information is first acquired from a plurality of users for each feature amount (step S1). Next, a feature amount change model is constructed for each feature amount by a regression analysis being performed on the feature amount survival period information (step S2). The inference device 1 stores the feature amount change model (step S3).

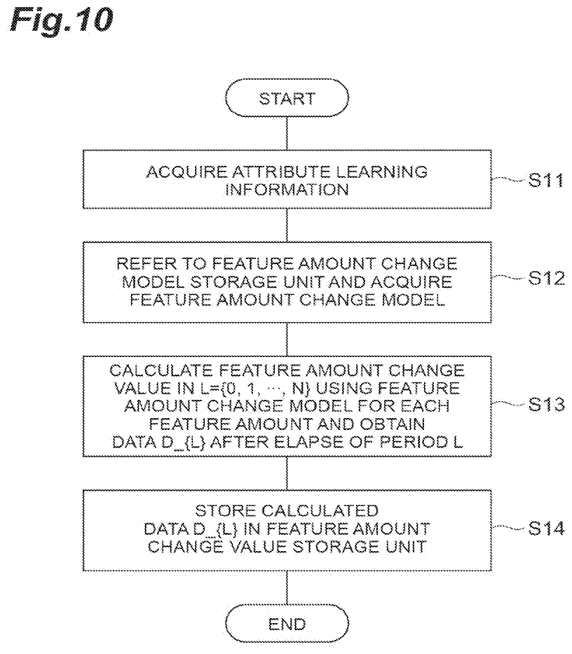

FIG. 10 is a flowchart illustrating processing related to the derivation of the value (change value) of a feature amount for each period. As shown in FIG. 10, in the inference device 1, attribute learning information relating to each feature amount is first acquired from a plurality of users (step S11). Next, the stored feature amount change model is acquired (step S12). Next, the value (change value) of each user's feature amount in each period is derived by the attribute learning information being input to the feature amount change model for each feature amount (step S13). The inference device 1 stores the derived value (change value) of each user's feature amount in each period (step S14).

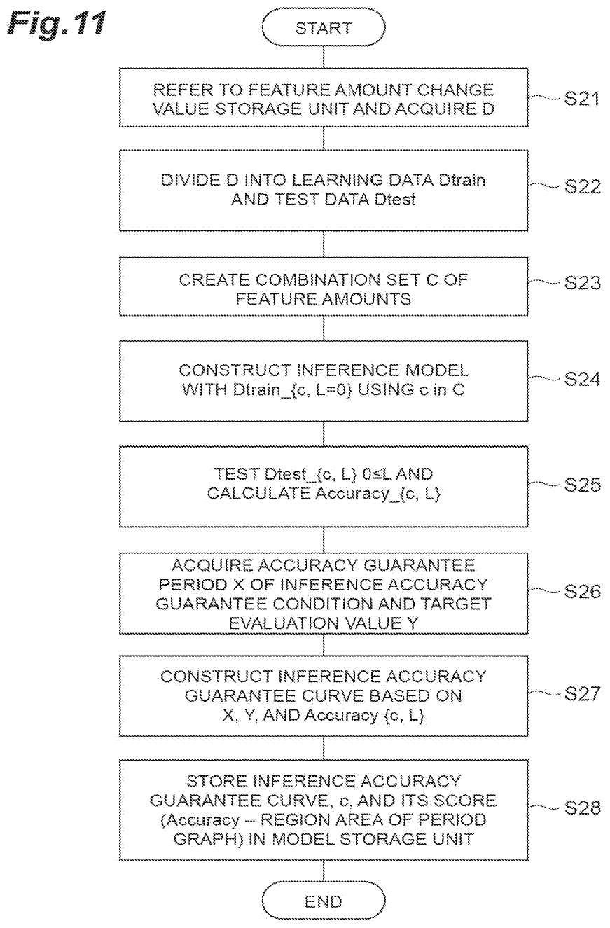

FIG. 11 is a flowchart illustrating processing related to the construction of an attribute inference model and the evaluation of the attribute inference model. As shown in FIG. 11, in the inference device 1, the value (change value) D of each user's feature amount in each period is first acquired from the feature amount change value storage unit 22 (step S21). Next, the change value D is divided into learning data Dtrain and test data Dtest (step S22). For example, a combination set C of feature amounts as shown in FIG. 4 is generated (step S23). The inference device 1 constructs an attribute inference model by learning the learning data Dtrain for each combination of each feature amount (step S24). By the test data Dtest being input to the constructed attribute inference model, the accuracy of inference of an attribute inference model in each period is derived and the attribute inference model is evaluated (step S25).

Next, in the inference device 1, the inference guarantee period X of the inference accuracy guarantee condition and the target evaluation value Y are acquired (step S26). An inference accuracy guarantee curve is constructed on the basis of the period X, the target value Y, and the evaluation value in each period (step S27). Finally, a combination of each feature amount in which the attribute inference model is constructed, each generated inference accuracy guarantee curve, and the score and validity period of each inference accuracy guarantee curve are stored in the attribute inference model storage unit 31 (step S28).

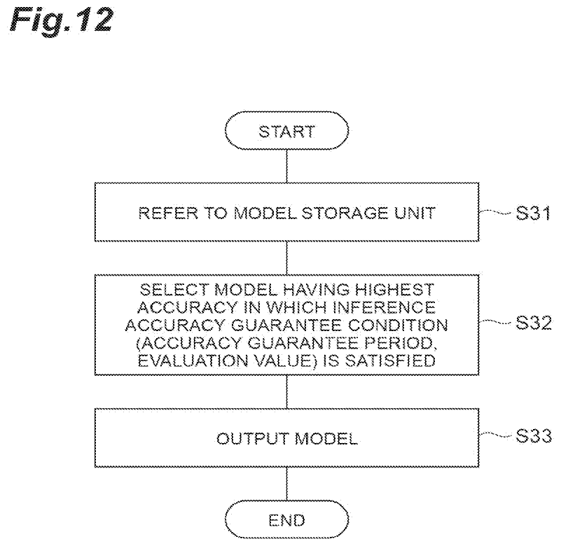

FIG. 12 is a flowchart illustrating an output process of an attribute inference model. As shown in FIG. 12, in the inference device 1, the attribute inference model storage unit 31 is first referred to (step S31), and an attribute inference model having a highest accuracy in which the inference accuracy guarantee condition is satisfied is selected (step S32). The inference device 1 outputs the selected attribute inference model (step S33).

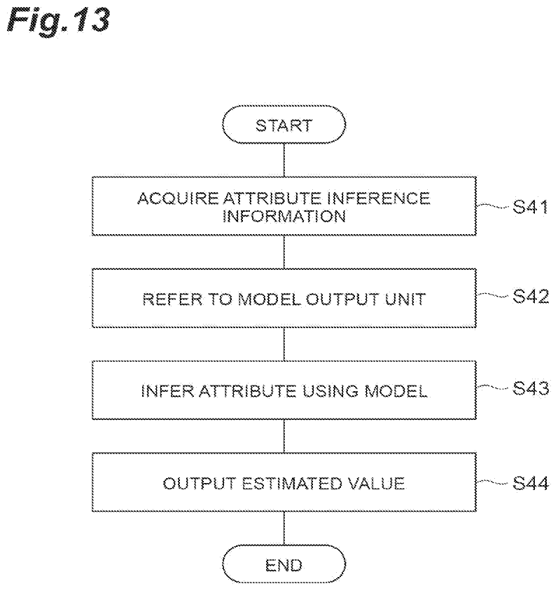

FIG. 13 is a flowchart illustrating processing related to a user's attribute inference. As shown in FIG. 13, in the inference device 1, the attribute inference information is first acquired (step S41). Next, the output result of the model output unit 50 is referred to (step S42), and a user's attribute is inferred by the attribute inference information being input to the attribute inference model (step S43). Finally, the inference device 1 outputs a score (estimated value) which is the accuracy of a user's attribute (step S44).

Next, the operational effects of the present embodiment will be described.

The inference device 1 according to the present embodiment includes the survival period information input unit 10 that acquires survival period information indicating a change in the value of a feature amount over a period of time from a plurality of users (observation subjects) for each feature amount, the feature amount change model construction unit 11 that constructs a feature amount change model that predicts a change in the value of a feature amount for each feature amount by performing a regression analysis using the survival period information, the attribute learning information input unit 20 that acquires attribute learning information relating to each feature amount from a plurality of users (observation subjects), the feature amount change inference unit 21 that derives a value of each feature amount for each period from a plurality of users (observation subjects) by applying the feature amount change model of each feature amount to the attribute learning information, the attribute inference model construction unit 30 that constructs an attribute inference model that infers an attribute of a user (observation subject) for each combination of each feature amount, and the model evaluation unit 41 that derives the accuracy of inference of each attribute inference model in each period on the basis of the value of each feature amount in each period for a plurality of users (observation subjects) derived by the feature amount change inference unit 21.

In such an inference device 1, the value of a feature amount for each period is derived by the feature amount change model constructed on the basis of the survival period information. The accuracy of inference in each period of the attribute inference model constructed for each combination of each feature amount is derived on the basis of the value of each feature amount in each period for a plurality of users (observation subjects). In this way, in the inference device 1, since the accuracy of inference of each attribute inference model in each period is derived in consideration of a change in the value of a feature amount due to the elapse of a period, it is possible to appropriately infer a change in the accuracy of inference over a period of time (deterioration of each attribute inference model over time) for each attribute inference model. This makes it possible to select an attribute inference model which is not likely to deteriorate early and to suppress a decrease in the accuracy of inference over a period of time. That is, it is possible to construct a model which is effective in estimating a long-term attribute of a user (observation subject). In addition, since a change in the accuracy of inference over a period of time (period of deterioration over time) can be specified, it is possible to appropriately set the update frequency of an attribute inference model and to calculate the development cost of the inference device or the like with a high degree of accuracy. Meanwhile, by appropriately ascertaining a change in the accuracy of inference over a period of time, it is possible to appropriately estimate a short-term attribute of a user (observation subject) (such as a person's life event) using, for example, an attribute inference model of a combination of feature amounts having a short survival period. As described above, since an attribute inference model which is not likely to deteriorate early can be appropriately selected, it is possible to suppress the amount of processing related to the selection of an attribute inference model and to attain the technical effect of reducing a processing load in a processing unit such as a CPU.

The inference device 1 includes the inference accuracy guarantee condition input unit 40 that acquires a guarantee condition which is a condition regarding the guarantee period of a predetermined accuracy of inference and the model output unit 50 that outputs the attribute inference model in which the accuracy of inference in each period derived by the model evaluation unit 41 satisfies the guarantee condition. This makes it possible to output only an attribute inference model in which the accuracy of inference which is set in advance is secured in a predetermined period, that is, only an attribute inference model capable of inferring an attribute of a user (observation subject) with a high degree of accuracy in a desired period.

The inference device 1 includes the attribute inference information input unit 60 that acquires attribute inference information relating to a feature amount of the attribute inference model which is output by the model output unit 50 from a user (observation subject), the inference processing unit 61 that infers an attribute of a user (observation subject) by inputting the attribute inference information to the attribute inference model which is output by the model output unit 50, and the inference result output unit 62 that outputs an inference result of the inference processing unit 61. This makes it possible to infer and output an attribute of a user (observation subject) with a high degree of accuracy using an attribute inference model which is not likely to deteriorate over time.

The model output unit 50 further outputs a period in which the attribute inference model to be output satisfies the predetermined accuracy of inference related to the guarantee condition as a validity period (model validity period). This makes it possible to appropriately notify a model constructor of how long the accuracy of inference is secured in an attribute inference model.

The inference result output unit 62 further outputs the above-described validity period (model validity period) as a guarantee period of the inference result. This makes it possible to appropriately set the guarantee period of the inference result and to appropriately notify a model constructor of a period in which the inference result is valid by outputting the guarantee period of the inference result.

The feature amount change model construction unit 11 constructs the feature amount change model by applying a Weibull distribution to the survival period information. This makes it possible to appropriately construct a feature amount change model considering a deterioration phenomenon with time (deterioration over time).

The attribute inference model construction unit 30 constructs the attribute inference model on the basis of the attribute learning information. This makes it possible to construct an attribute inference model having a high accuracy of inference on the basis of the actual feature amounts of a plurality of users (observation subjects) instead of estimated values.

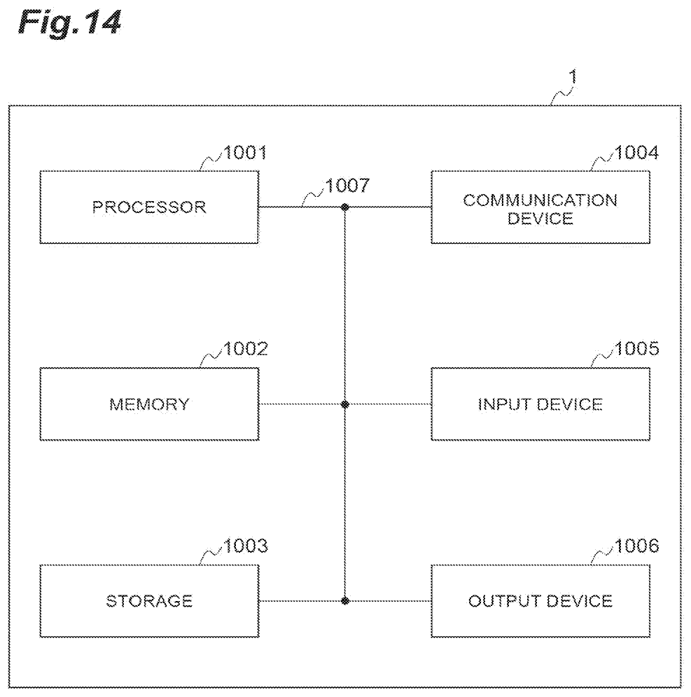

Finally, the hardware configuration of the inference device 1 will be described with reference to FIG. 14. The above-described inference device 1 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the inference device 1 may be configured to include one or a plurality of devices shown in the drawings, or may be configured without including some of the devices.

The processor 1001 performs an arithmetic operation by reading predetermined software (a program) on hardware such as the processor 1001 or the memory 1002, and thus each function in the inference device 1 is realized by controlling communication in the communication device 1004 and reading and/or writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like. For example, the control function of the model evaluation unit 41 of the inference device 1 or the like may be realized by the processor 1001.

In addition, the processor 1001 reads out a program (program code), a software module and data from the storage 1003 and/or the communication device 1004 into the memory 1002, and executes various types of processes in accordance therewith. An example of the program which is used is a program causing a computer to execute at least some of the operations described in the foregoing embodiment. For example, the control function of the model evaluation unit 41 of the inference device 1 or the like may be realized by a control program which is stored in the memory 1002 and operates in the processor 1001, and other functional blocks may be realized in the same manner. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RANI), and the like. The memory 1002 may be referred to as a register, a cache, a main memory (main storage device), or the like. The memory 1002 can store a program (program code), a software module, or the like that can be executed in order to carry out a wireless communication method according to an embodiment of the present invention.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including the memory 1002 and/or the storage 1003, a server, or other suitable media.

The communication device 1004 is hardware (a transmitting and receiving device) for performing communication between computers through a wired and/or wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel).

In addition, respective devices such as the processor 1001 and the memory 1002 are connected to each other through the bus 1007 for communicating information. The bus 1007 may be constituted by a single bus, or may be constituted by different buses between devices.

In addition, the inference device 1 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, at least one of these types of hardware may be mounted in the processor 1001.

Hereinbefore, the present embodiments have been described in detail, but it is apparent to those skilled in the art that the present embodiments should not be limited to the embodiments described in this specification. The present embodiments can be implemented as modified and changed aspects without departing from the spirit and scope of the present invention, which are determined by the description of the scope of claims. Therefore, the description of this specification is intended for illustrative explanation only, and does not impose any limited interpretation on the present embodiments.

The aspects/embodiments described in this specification may be applied to systems employing long term evolution (LTE), LTE-advanced (LTE-A), SUPER 3G, IMT-Advanced, 4G, 5G, future radio access (FRA), W-CDMA (registered trademark), GSM (registered trademark), CDMA2000, ultra-mobile broad band (UMB), IEEE 802.11 (Wi-Fi), IEEE 802.16 (WiMAX), IEEE 802.20, ultra-wide band (UWB), Bluetooth (registered trademark), or other appropriate systems and/or next-generation systems to which these systems are extended on the basis thereof.

The order of the processing sequences, the flowcharts, and the like of the aspects/embodiments described above in this specification may be changed as long as they are compatible with each other. For example, in the methods described in this specification, various steps as elements are described in an exemplary order but the methods are not limited to the described order.

The input or output information or the like may be stored in a specific location (for example, a memory) or may be managed in a management table. The input or output information or the like may be overwritten, updated, or added. The output information or the like may be deleted. The input information or the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects described in this specification may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Regardless of whether it is called software, firmware, middleware, microcode, hardware description language, or another name, software can be widely construed to refer to commands, a command set, codes, code segments, program codes, a program, a sub-program, a software module, an application, a software application, a software package, a routine, a sub-routine, an object, an executable file, an execution thread, an order, a function, or the like.

In addition, Software, a command, and the like may be transmitted and received via a transmission medium. For example, when software is transmitted from a web site, a server, or another remote source using wired technology such as a coaxial cable, an optical fiber cable, a twisted-pair wire, or a digital subscriber line (DSL) and/or wireless technology such as infrared rays, radio waves, or microwaves, the wired technology and/or the wireless technology are included in the definition of a transmission medium.

Information, a signal or the like described in this specification may be expressed using any of various different techniques. For example, data, an instruction, a command, information, a signal, a bit, a symbol, and a chip which can be mentioned in the overall description may be expressed by a voltage, a current, an electromagnetic wave, a magnetic field or magnetic particles, an optical field or photons, or any combination thereof.

Meanwhile, the terms described in this specification and/or the terms required for understanding this specification may be substituted by terms having the same or similar meanings.

In addition, information, parameters, and the like described in this specification may be expressed as absolute values, may be expressed by values relative to a predetermined value, or may be expressed by other corresponding information.

A user terminal may also be referred to as a mobile communication terminal, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

The term “determining” which is used in this specification may include various types of operations. The term “determining” may include regarding operations such as, for example, calculating, computing, processing, deriving, investigating, looking up (for example, looking up in a table, a database or a separate data structure), or ascertaining as an operation such as “determining” In addition, the term “determining” may include regarding operations such as receiving (for example, receiving information), transmitting (for example, transmitting information), input, output, or accessing (for example, accessing data in a memory) as an operation such as “determining” In addition, the term “determining” may include regarding operations such as resolving, selecting, choosing, establishing, or comparing as an operation such as “determining” That is, the term “determining” may include regarding some kind of operation as an operation such as “determining.”

An expression “on the basis of ˜” which is used in this specification does not refer to only “on the basis of only ˜,” unless otherwise described. In other words, the expression “on the basis of ˜” refers to both “on the basis of only ˜” and “on the basis of at least ˜.”

Any reference to elements having names such as “first” and “second” which are used in this specification does not generally limit amounts or an order of the elements. The terms can be conveniently used to distinguish two or more elements in this specification. Accordingly, reference to first and second elements does not mean that only two elements are employed or that the first element has to precede the second element in any form.

Insofar as the terms “include” and “including” and modifications thereof are used in this specification or the claims, these terms are intended to have a comprehensive meaning similarly to the term “comprising.” Further, the term “or” which is used in this specification or the claims is intended not to mean an exclusive logical sum.

In this specification, a single device is assumed to include a plurality of devices unless only one device may be present in view of the context or the technique.

In the entire disclosure, a singular form is intended to include a plural form unless the context indicates otherwise.

### REFERENCE SIGNS LIST

1 Inference device
10 Survival period information input unit (first acquisition unit)
11 Feature amount change model construction unit (first model construction unit)
20 Attribute learning information input unit (second acquisition unit)
21 Feature amount change inference unit
30 Attribute inference model construction unit (second model construction unit)
40 Inference accuracy guarantee condition input unit (third acquisition unit)
41 Model evaluation unit
50 Model output unit
60 Attribute inference information input unit (fourth acquisition unit)
61 Inference processing unit
62 Inference result output unit

1: An inference device comprising:
a first acquisition unit configured to acquire survival period information indicating a change in a value of a feature amount over a period of time from a plurality of observation subjects for each feature amount;
a first model construction unit configured to construct a feature amount change model that predicts a change in a value of a feature amount for each feature amount by performing a regression analysis using the survival period information;
a second acquisition unit configured to acquire attribute learning information relating to each feature amount from a plurality of observation subjects;
a feature amount change inference unit configured to derive a value of each feature amount for each period from a plurality of observation subjects by applying the feature amount change model of each feature amount to the attribute learning information;
a second model construction unit configured to construct an attribute inference model that infers an attribute of an observation subject for each combination of each feature amount; and
a model evaluation unit configured to derive accuracy of inference of each attribute inference model in each period on the basis of a value of each feature amount in each period for a plurality of observation subjects derived by the feature amount change inference unit.

2: The inference device according to claim 1, further comprising:
a third acquisition unit configured to acquire a guarantee condition which is a condition regarding a guarantee period of a predetermined accuracy of inference; and
a model output unit configured to output the attribute inference model in which the accuracy of inference in each period derived by the model evaluation unit satisfies the guarantee condition.

3: The inference device according to claim 2, further comprising:
a fourth acquisition unit configured to acquire attribute inference information relating to a feature amount of the attribute inference model which is output by the model output unit from an observation subject;
an inference processing unit configured to infer an attribute of an observation subject by inputting the attribute inference information to the attribute inference model which is output by the model output unit; and
an inference result output unit configured to output an inference result of the inference processing unit.

4: The inference device according to claim 3, wherein the model output unit further outputs a period in which the attribute inference model to be output satisfies the predetermined accuracy of inference related to the guarantee condition as a model validity period.

5: The inference device according to claim 4, wherein the inference result output unit further outputs the model validity period as a guarantee period of the inference result.

6: The inference device according to claim 1, wherein the first model construction unit constructs the feature amount change model by applying a Weibull distribution to the survival period information.

7: The inference device according to claim 1, wherein the second model construction unit constructs the attribute inference model on the basis of the attribute learning information.
